(19) United States
(12) Patent Application Publication
(10) Pub. No.: US 2022/0028088 A1
(43) Pub. Date: Jan. 27, 2022

(54) MULTI-SCALE SEGMENTATION SYSTEM

(71) Applicant: Vingroup Joint Stock Company, Ha Noi city (VN)

(72) Inventors: Hung Hai BUI, Ha Noi city (VN); Hoai Minh Nguyen, Ha Noi city (VN); Khoa Luu, Ha Noi city (VN); Anh Tuan Tran, Ha Noi city (VN); Chuong Minh Huynh, Ha Noi city (VN)

(21) Appl. No.: 17/160,509

(22) Filed: Jan. 28, 2021

(30) Foreign Application Priority Data
Jul. 23, 2020 (VN) 1-2020-04289

(51) Int. Cl. G06T 7/174; G06T 3/40; G06N 3/08

(52) U.S. Cl. CPC G06T 7/174; G06T 3/40; G06T 2207/20212; G06T 2207/20016; G06T 2207/20021; G06N 3/08

(57) ABSTRACT

According to an exemplary embodiment, provided is a multi-scale segmentation system including a plurality of processing devices that correspond to multiple image scale levels, wherein the multi-scale segmentation system applies for having any number of image scale levels and wherein each processing device that corresponds to a specific image scale level is configured to receive a source image and one or more output segmentation maps generated from one or more previous processing devices, divide the received source image in association with the received one or more output segmentation maps into image patches wherein a size of image patches corresponds to a specific image scale level, and identify semantic objects in the image patches to generate an output segmentation map.

### CROSS REFERENCE TO RELATED APPLICATION

This application claims priority from Vietnamese Patent Application No. 1-2020-04289 filed on 23 Jul. 2020, which application is incorporated herein by reference in its entirety.

### TECHNICAL FIELD

One exemplary embodiment of the present invention relates to a multi-scale segmentation system, and more particularly, to a multi-scale segmentation system applicable to semantic image segmentation of a high resolution image.

### RELATED ART

Semantic image segmentation is an operation of allocating a semantic category to each pixel of an input image. This is an important computer vision problem in a wide range of applications from automatic driving and aerial surveillance to medical diagnosis and disease monitoring.

Latest technologies for semantic image segmentation are based on deep learning. The convolutional neural network (CNN) technology can output a segmentation map using an input image.

In the conventional technologies, it is assumed that an entire segmentation process can be performed through a single feed-forward pass of an input image and an entire process may be fit into a graphics processing unit (GPU) memory. However, most conventional technologies cannot process a high resolution input image due to memory limitations and other calculative limitations. As one method of processing a high resolution input image, there is a method of downsampling an image. In this case, a low resolution segmentation map is generated, which is not suitable for applications requiring high resolution output in the field of medicine for tracking the progression of malignant lesions.

As another method of processing a high resolution input image, there is a method of dividing an image into local patches and processing each patch independently. However, the method has a problem in that global information necessary to resolve the ambiguity of the local patch is not taken into account.

In order to solve the problem, a method of combining global and local segmentation processes has been applied. The ambiguity of the shape of a local patch may be resolved through a global view of an entire image, and by analyzing the local patch, it is possible to refine a segmentation boundary and recover lost detailed information generated from a downsampling procedure of the global segmentation process.

However, when an ultra-high resolution input image is used, there is a great difference between a scale of an entire image and a scale of a local patch. This will lead to contrasting output segmentation maps, and there are difficulties in combining and adjusting differences with a single feed-forward processing operation.

### SUMMARY

The present invention is directed to providing a multi-scale segmentation system capable of segmenting a high resolution image without overloading usage of a graphics processing unit (GPU) memory and without losing detailed information in an output segmentation map.

According to an aspect of the present invention, there is provided a multi-scale segmentation system including a plurality of processing devices that correspond to multiple image scale levels, wherein the multi-scale segmentation system applies for having any number of image scale levels, and wherein each processing device that corresponds to a specific image scale level is configured to receive a source image and one or more output segmentation maps generated from one or more previous processing devices, divide the received source image in association with the received one or more output segmentation maps into image patches wherein a size of image patches corresponds to the specific image scale level, and identify semantic objects in the image patches to generate an output segmentation map.

The processing device may include a preprocessing unit which processes the source image in association with the one or more segmentation maps output from the one or more previous processing devices, an image patch unit which divides the input source image processed in association with the one or more segmentation maps by the preprocessing unit into the image patches having a preset size, a downsampling unit which performs downsampling on the divided image patches, a segmentation unit which identifies the semantic objects in the downsampled image patches to output segmentation images, an upsampling unit which performs upsampling on the segmentation images, and an image combining unit which combines sets of the upsampled segmentation images to generate the output segmentation map.

The segmentation unit may include a neural network which learns segmentation using labeled learning data to output the segmentation images.

The segmentation unit may be trained by optimizing a focal loss between a mask of an output segmentation map and a segmentation mask of a ground truth.

The segmentation unit may learn segmentation by calculating a consistency loss based on the consistency of the output segmentation map with segmentation maps of all previous processing devices, and then applying a loss function calculated according to a weighted linear combination value of the focal loss and the consistency loss.

A size of a current processing device image patch may be smaller than a size of a previous processing device image patch.

### BRIEF DESCRIPTION OF THE DRAWINGS

FIG. 1 is a block diagram of a multi-scale segmentation system according to an exemplary embodiment.

FIG. 2 illustrates an architecture and process of the multi-scale segmentation system according to the exemplary embodiment.

FIGS. 3 to 5 are views for describing results of an operation experiment of the multi-scale segmentation system according to the exemplary embodiment.

### DETAILED DESCRIPTION

Hereinafter, exemplary embodiments of the present invention will be described in detail with reference to the accompanying drawings.

However, the technical spirit of the present invention is not limited to the exemplary embodiments disclosed below but can be implemented in various different forms. Without departing from the technical spirit of the present invention, one or more components may be selectively combined and substituted to be used between the exemplary embodiments.

Also, unless defined otherwise, terms (including technical and scientific terms) used herein may be interpreted as having the same meaning as commonly understood by one of ordinary skill in the art to which the present invention belongs. General terms like those defined in a dictionary may be interpreted in consideration of the contextual meaning of the related technology.

Furthermore, the terms used herein are intended to illustrate exemplary embodiments and are not intended to limit the present invention.

In the present specification, terms in singular form may include plural forms unless otherwise specified. When “at least one (or one or more) of A, B, and C” is expressed, it may include one or more of all possible combinations of A, B, and C.

In addition, terms such as “first,” “second,” “A,” “B,” “(a),” and “(b)” may be used herein to describe components of the exemplary embodiments of the present invention.

Such terms are not used to define an essence, order, or sequence of a corresponding component but used merely to distinguish the corresponding component from other components.

In a case in which one component is described as being “connected,” “coupled,” or “joined” to another component, such a description includes both a case in which one component is “connected,” “coupled,” and “joined” directly to another component and a case in which one component is “connected,” “coupled,” and “joined” to another component with still another component disposed between one component and another component.

In addition, in a case in which any one component is described as being formed or disposed “on (or under)” another component, such a description includes both a case in which the two components are formed in direct contact with each other and a case in which the two components are in indirect contact with each other with one or more other components interposed between the two components. In addition, in a case in which one component is described as being formed “on (or under)” another component, such a description may include a case in which the one component is formed at an upper side or a lower side with respect to another component.

Hereinafter, exemplary embodiments will be described in detail with reference to the accompanying drawings, the same or corresponding components will be given the same reference numbers regardless of drawing symbols, and redundant descriptions will be omitted.

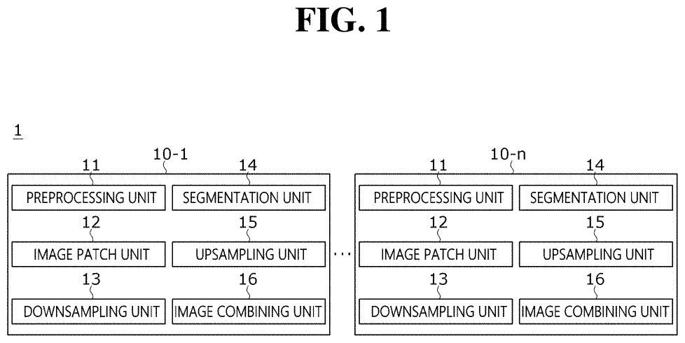

FIG. 1 is a block diagram of a multi-scale segmentation system according to an exemplary embodiment. Referring to FIG. 1, the present invention provides a multi-scale segmentation system 1 in a module type. In the following exemplary embodiments, the term “MagNet” may be used synonymously with the multi-scale segmentation system 1 according to the present invention. The multi-scale segmentation system according to the exemplary embodiment may include a plurality of processing devices 10-1 to 10-n which process images having different scale levels. According to an exemplary embodiment, n may be any number.

The present invention provides the effective multi-scale segmentation system 1 for segmenting a high-resolution image by sharing information between stages of the processing devices 10 without domination problems of a global branch.

In an exemplary embodiment, the multi-scale segmentation system 1 may be a multi-stage network architecture where each processing device 10 corresponds to a stage and corresponds to a specific image scale. In an exemplary embodiment, an input image may be inspected at multiple scales from a coarsest scale to a finest scale. According to an exemplary embodiment, the input image may be inspected at any number of scales. For example, the input image may be inspected at more than two scales.

An input of one processing device 10 may include one or more output segmentation maps of one or more previous processing devices, and the output segmentation maps may be gradually adjusted from lowest resolution to highest resolution.

In an exemplary embodiment, each stage of the processing devices 10 that are modular components may include units, and segmentation units 14 of the processing devices 10 may be sequentially trained. The segmentation unit 14 of each processing device 10 may perform a fine adjustment after individual learning.

In addition, a new loss function namely consistency loss may be applied to maintain consistency between output segmentation maps of different processing devices 10 in a training process.

The processing device 10 according to the exemplary embodiment may receive a source image and one or more output segmentation maps generated in one or more previous processing devices, may divide the received source image in association with the received one or more output segmentation maps into image patches wherein the size of image patches corresponds to the specific image scale level, and then may identify semantic objects in the image patches to generate an output segmentation map.

The multi-scale segmentation system 1 according to the exemplary embodiment may include a plurality of processing devices 10 where each processing device 10 corresponds to a specific image scale and each include a preprocessing unit 11, an image patch unit 12, a downsampling unit 13, the segmentation unit 14, an upsampling unit 15, and an image combining unit 16.

In an exemplary embodiment, the preprocessing unit 11 may process the source image in association with the one or more output segmentation maps output from the one or more previous processing devices.

In an exemplary embodiment, the image patch unit 12 may divide the input image processed in association with the one or more output segmentation maps by the preprocessing unit 11 into image patches having a preset size which corresponds to the specific image scale. In this case, a size of a current processing device image patch may be smaller than a size of a previous processing device image patch.

In an exemplary embodiment, the downsampling unit 13 may perform downsampling on the divided image patches.

In an exemplary embodiment, the segmentation unit 14 may identify semantic objects in the downsampled image patches to output segmentation images.

In addition, the segmentation unit 14 may include a neural network for learning segmentation using labeled learning data to output a segmentation image. The neural network may include a convolutional neural network (CNN) module.

Furthermore, the segmentation unit 14 may be trained by optimizing a focal loss between a mask of an output segmentation map and a segmentation mask of a ground truth.

In addition, the segmentation unit 14 may perform learning by calculating a consistency loss based on the consistency of the output segmentation map with segmentation maps of all previous processing devices and applying a loss function calculated according to a weighted linear combination value of the focal loss and the consistency loss.

In an exemplary embodiment, the upsampling unit 15 may perform upsampling on the segmentation images.

In an exemplary embodiment, the image combining unit 16 may combine sets of the upsampled segmentation images to generate the output segmentation map.

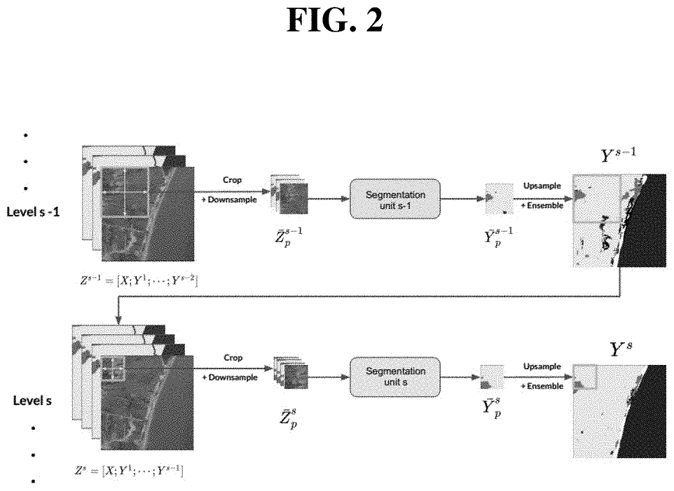

FIG. 2 illustrates an architecture and process of the multi-scale segmentation system according to the exemplary embodiment.

The multi-scale segmentation system 1 according to the exemplary embodiment may include m processing devices 10. m represents a hyperparameter for the number of scales to be analyzed. S represents the numbering of each processing device. In an exemplary embodiment, s=1 corresponds to a scale of a coarsest stage, and s=m corresponds to a scale of a finest stage. X ∈ [symbol] ^{H×W×3} represents an input image. H and W represent a height and a width of an image.

When H and W are too great for the input image X to be processed without downsampling, h and w may be a maximum height and a maximum width of an image which may be processed by each processing device 10. A height and width of an image processed at a scale level s may be represented by h^{s} and w^{s}. Each processing device 10 may determine a scale level as shown in Equation 1 below such that the scale level extends in an entire scale space.

H=h¹> . . . >h^{m}=h

W=w¹> . . . >w^{m}= [Equation 1]

In the case of a specific scale level s, the input image X may be divided into patches having a size of h^{s}×w^{s} (which may overlap each other), and semantic segmentation may be performed on the patches. Positions of the patches are defined by a set of rectangular windows, and P^{s} represents the set of windows. That is, the positions may be defined as P^{s}={p|p=(x, y, w^{s}, h^{s})}. Here, x and y coordinates of each window may be designated by a top left corner position.

As the scale level s increases, a width and height of the rectangular window decrease, but cardinality of P^{s} increases. In the case of a specific window, an image patch extracted from a window p may be represented using Xₚ. The processing device 10 according to the exemplary embodiment receives the input image X ∈ [symbol] ^{H×W×3} and generates a series of output segmentation maps Y¹, . . . , Y^{m} ∈ [symbol] ^{H×W×3}. C represents the number of applicable semantic categories.

Hereinafter, operations of the processing device 10 at the specific scale level s will be described. Except for the operation of the processing device 10 at a coarsest scale level stage, all processing devices 10 may perform the same operation. In the case of the coarsest scale level, since an output segmentation map of a previous processing device may not be input, operations of the preprocessing unit 11 may be omitted.

First, the preprocessing unit 11 associates a source image with one or more output segmentation maps output from one or more previous processing devices. The preprocessing unit 11 generates a three-dimensional (3D) tensor by processing the input source image in association with the one or more output segmentation maps output from the one or more previous processing devices. In exemplary embodiments, Z^{s} represents the 3D tensor: Z^{s} [X; Y¹; . . . ; Y^{s-1}].

Next, the image patch unit 12 divides the input image processed in association with the one or more output segmentation maps from the one or more previous processing devices by the preprocessing unit 11 into image patches having a preset size. The image patch unit 12 determines a set of rectangular windows P^{s} for patch division.

After that, the processing device 10 performs operations (a) to (d) on each window p∈P^{s} where window p corresponds to an image patch.

(a) The image patch unit 12 extracts a sub-tensor Zₚ^{s} defined by the window p. The sub-tensor is a tensor having a size of h^{s}×w^{s}×(3+(s−1)C).

(b) The downsampling unit 13 performs downsampling on the divided image patches. The downsampling unit downsamples Zₚ^{s} so that the downsampling unit has a new height and width, i.e., a size of h and w which may be processed by the segmentation unit 14. A downsampled tensor may be represented as Z̅ₚ^{s}.

(c) The segmentation unit 14 identifies semantic objects in the downsampled image patches to output segmentation images. The segmentation unit 14 inputs Z̅ₚ^{s} into a CNN module to obtain a segmentation image Y̅ₚ^{p}∈ [symbol] ^{h×w×3}.

In this case, the segmentation unit 14 learns segmentation using labeled learning data. The learning data includes a plurality of pairs of source images and output segmentation maps (X, Y). Here, X is represented as X ∈ [symbol] ^{H×W×3} is and Y is represented as Y ∈ [symbol] ^{H×W×3}. The segmentation unit 14 of each processing device 10 learns stages from a stage 1 to a stage m. Parameters of the segmentation unit 14 with respect to a stage s are learned by optimizing a focal loss between a mask of an output segmentation map Y^{s} and a segmentation mask Y of a ground truth. A focal loss with respect to one pair of output segmentation maps is defined as an average of focal losses with respect to all spatial positions.

For example, a focal loss with respect to a spatial position (i, j) (1≤i≤H and 1≤j≤W) may be defined according to Equation 2 below:

$${L}_{i j}^{focal} = - {( 1 - {p}_{i j} )}^{γ} log ( {p}_{i j} ) , with {p}_{i j} = {\sum }_{i = 1}^{H} {Y}_{i j k} {Y}_{i j k}^{s} \qquad [ Equation 2 ]$$

In Equation 2, Yᵢⱼₖ represents a value in a row i, a column j, and a channel k of a 3D tensor Y. A parameter γ (≥0) is a focusing hyperparameter. In an exemplary embodiment, γ is set to 3. A loss value in a mask of an entire output segmentation map may be an average of focal losses in all spatial positions and may be defined according to Equation 3 below:

$${L}^{focal} = \frac{1}{H W} {\sum }_{i = 1}^{H} {\sum }_{j = 1}^{W} {L}_{i j}^{focal} \qquad [ Equation 3 ]$$

In an exemplary embodiment, an output segmentation map is gradually improved after a stage of each processing device of a multi-scale segmentation system. Since a scale difference between two consecutive processing devices is small, when any processing device proceeds to a next processing device, an abrupt change does not occur in an output segmentation map.

In addition, a loss function, in which partial consistency between output segmentation maps is maintained, is applied for fast learning of the segmentation unit 14. When segmentation images Y^{s} and Y^{t} of stages s and t are given, a partial consistency value between Y^{s} and Y^{t} may be defined according to Equation 4 below:

$${L}_{s , t}^{c o n s i s t e n c y} = \frac{1}{H W} {\sum }_{i = 1}^{H} {\sum }_{j = 1}^{W} max ( {‖ {Y}_{i j}^{s} - {Y}_{i j}^{t} ‖}_{2} - λ , 0 ) \qquad [ Equation 4 ]$$

In Equation 4, λ(0≤λ<<1) represents a hyperparameter for a consistency margin. When a distance L₂ (norm or Euclidean norm L₂) between output vectors is smaller than a margin term, a consistency loss becomes zero. In an exemplary embodiment, when λ is 0.05, a consistency loss appears to be the smallest.

Assuming that the segmentation unit 14 learns for a stage s, a consistency loss may be defined according to Equation 5 below based on the consistency of an output segmentation map with output segmentation maps of all previous stages.

$${L}^{c o n s i s t e n c y} = {\sum }_{t = 1}^{s - 1} {β}^{s - 1 - t} {L}_{s , t}^{reg} \qquad [ Equation 5 ]$$

In Equation 5, a consistency loss may be defined as a weighted linear combination of partial consistency values. A combination weight for consistency between a stage s and a stage t may depend on a difference between s and t and may be actually represented by an exponential decay function of an adjustable hyperparameter β (0≤β≤1). In an exemplary embodiment, β is set to 0.5.

A loss function for learning of the segmentation unit 14 in the stage s may be represented by a weighted linear combination of a focal loss and a partial consistency loss according to Equation 6 below:

Lₛ=L^{focal}+αL^{consistency}. [Equation 6]

In Equation 6, a represents a hyperparameter for controlling strength of partial consistency. In an exemplary embodiment, α is set to 0.2.

d) The upsampling unit 15 performs upsampling on the segmentation images. The upsampling unit 15 upsamples Y̅ₚ^{s} to obtain Yₚ^{s} having a size of h^{s}×w^{s}×C.

Next, the image combining unit 16 combines the upsampled segmentation images to generate an output segmentation map. The image combining unit 16 combines sets of patch unit output segmentation images {Yₚ^{s}|p∈P^{s}} to generate an output segment map Y^{s} with respect to the scale level s. In this case, the output segmentation map has further improved resolution as compared with the output segmentation maps of the previous processing devices.

### Experiments

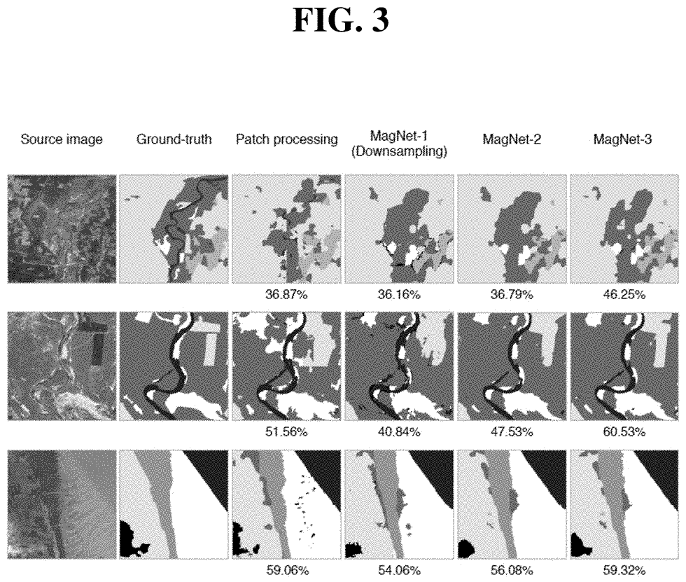

FIGS. 3 to 5 show the results of the operation experiments of the multi-scale segmentation system according to the embodiment.

The present experiments evaluate the performance of the system on the three high resolution datasets DeepGlobe, Inria Aerial and Indian Diabetic Retinopathy Image Dataset (IDRID). The first two datasets consist of satellite images, while the last one is a collection of retina images with highly imbalanced foreground and background classes. The experiments compare the method according to embodiment of the sytem with other state-of-the-art methods in semantic segmentation and also describe some ablation studies.

### Implementation Details

Each dataset was experimented with different rescaled sizes and considered patches from multiple scales. The experiments used overlapping patches to generate augmented training data, but did not use overlapping patches during testing.

For training, the experiments also performed other types of data augmentation: rotation, and horizontal and vertical flipping. The experiments used Adam optimizer (01=0:9, 02=0.999) with initial learning rate 10⁻³ for the coarsest scale and 5×10⁻⁴ for other scales. For the coarsest scale, the experiments trained the segmentation module with 120 epochs; the initial learning rate was 10⁻³, and the learning rate was halved every 30 epochs. For other scale levels, the experiments trained with 50 epochs; the learning rate was set initially at 5×10⁻⁴, and it was halved every 10 epochs. The experiments implemented the present invention using PyTorch as reported in Pytorch: An imperative style, high performance deep learning library in: Advances in Neural Information Processing Systems. pp. 8024-8035 (2019) of Paszke, A., Gross, S., Massa, F., Lerer, A., Bradbury, J., Chanan, G., Killeen, T., Lin, Z., Gimelshein, N., Antiga, L., et al. and performed all experiments on a DGX-1 workstation with Tesla V100 GPU cards.

### 1. Experiments on the DeepGlobe Satellite Dataset

DeepGlobe is a dataset of high resolution satellite images. The dataset contains 803 images, annotated with seven landscape classes. The size of the images is 2048×2048 pixels. The experiments used the same train/validation/test split used by GLNet as reported in Collaborative global-local networks for memory-efficient segmentation of ultra-high resolution images in Proceedings of the IEEE Conference on Computer Vision and Pattern Recognition. pp. 8924-8933 (2019) of Chen, W., Jiang, Z., Wang, Z., Cui, K., Qian, X. (incorporated herein by reference), with 455, 207 and 142 images for training, validation and testing, respectively.

### 1.1. Training Procedure

Multi-scale segmentation system of the present invention can be used with any backbone network, and the experiments choose to use Feature pyramid network (FPN) as reported in Feature pyramid network for multi-class land segmentation in CVPR Workshops. pp. 272-275 (2018) of Seferbekov, S. S., Iglovikov, V., Buslaev, A., Shvets, A (incorporated herein by reference) with Resnet-50 because it was shown to achieve the best performance on this dataset by previous work. The experiments considered three scale levels, corresponding to patch sizes of 2448×2448, 1224×1224, and 612×612. The size of input image to a segmentation unit (i.e., the size that each image patch was rescaled to) was 508×508, which was the same as the one used by GLNet. Other methods were trained and evaluated with publicly available source code from the authors with the same configuration as described above.

### 1.2. Accuracy Comparison

TABLE 1

| | | | | |
|---|---|---|---|---|
| Model | Patch size | #patches | mIoU(%) | Memory(MB) |

Downsampling

| | | | | |
|---|---|---|---|---|
| U-net [27] | 2448 × 2448 | 1 | 43.12 | 1813 |
| FCN-8s [20] | 2448 × 2448 | 1 | 45.62 | 10569 |
| SegNet [1] | 2448 × 2448 | 1 | 52.41 | 2645 |
| DeepLabv3+ [2] | 2448 × 2448 | 1 | 61.30 | 1541 |

Patch processing

| | | | | |
|---|---|---|---|---|
| U-net [27] | 612 × 612 | 16 | 40.55 | 1813 |
| FCN-8s [20] | 612 × 612 | 16 | 55.71 | 10569 |
| SegNet [1] | 612 × 612 | 16 | 61.24 | 2645 |
| DeepLapv3+ [2] | 612 × 612 | 16 | 63.10 | 1541 |

Context aggregation

| | | | | |
|---|---|---|---|---|
| GLNet [4] | 2448 × 2448 | 1 | 62.69 | 1481 |
| (global) | | | | |
| GLNet [4] | 508 × 508 | 36 | 65.84 | 1395 |
| (local) | | | | |
| GLNet [4] | mixed | 1 + 36 | 65.93 | 1865 |
| (aggregation) | | | | |
| MagNet-1 | 2448 × 2448 | 1 | 58.60 | 1481 |
| MagNet-2 | 1224 × 1224 | 1 + 4 | 62.61 | 1407 |
| MagNet-3 | 612 × 612 | 1 + 4 + 16 | 67.45 | 1369 |

Table 1 shows performance of MagNet and other semantic segmentation methods on the DeepGlobe dataset. In table 1, all images and patches are resized to 508×508 pixels before feeding to a segmentation model.

Table 1 compares the performance of MagNet system with several state-of-the-art semantic segmentation methods. The methods are grouped into three categories, depending on whether they are downsampling, patch processing, or context aggregation methods.

The experiments described in table 1 trained MagNet for three scales. MagNet-1, MagNet-2, and MagNet-3 refer to the first, second, and third stages of the present invention, with the patch sizes being 2448×2448; 1224×1224, and 612×612, respectively. That is to increase the strength of the magnifying glass by a factor of four as moving from one stage to the next.

MagNet-1 corresponds to the coarsest scale, and it is essentially a downsampling method, where the input image is resized to 508×508 before it can be processed by a segmentation unit. The backbone of the segmentation module is ResNet FPN, so the results of MagNet-1 and ResNet FPN are identical in Table 1. MagNet-3 is significantly better than MagNet-2, which is significantly better than MagNet-1. This illustrates the benefits of multi-scale progressive refinement.

Compared to MagNet-3, all downsampling methods perform relatively poorly, due to the lossy downsampling operation. MagNet-3 also outperforms patch processing and context aggregation methods. In terms of memory efficiency, MagNet-3 consumes 1481 MB GPU memory, which is 25% lower than the memory required by GLNet. The experiments used the library gpustat to compute the memory usage during the inference time with the batch size of 1.

FIG. 3 shows the segmentation outputs of a downsampling method, a patch processing method, and different processing stages of MagNet. While the patch processing method produces boundary artifact and wrong prediction due to the lack of global context, the downsampling method outputs noisy and coarse segmentation masks. MagNet combines the strengths of both approaches, and it produces a sequence of segmentation masks with increasing quality.

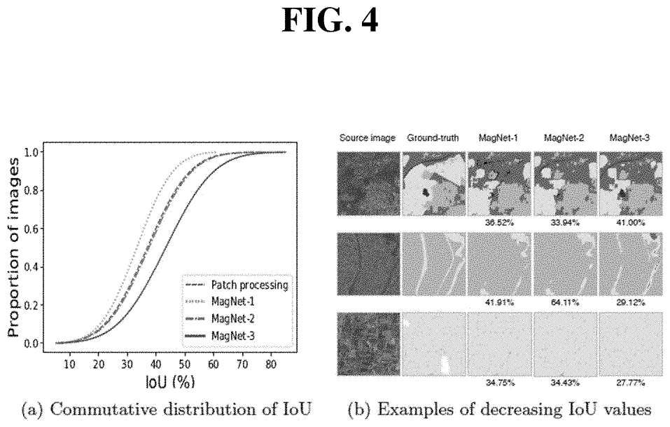

FIG. 4a plots the distribution of IoU values over test images for different processing stages of MagNet. As can be seen, the distribution shifts to the right as MagNet moves from one scale level to the next. The mean value increases from around 35% for MagNet-1 to about 50% for MagNet-3.

Overall, in 284 transitions between levels, the system of the present invention improved the IoU in 233 (82.04%) cases. However, there are 49 cases accounting for 17.25% in which the IoU decreases from one stage to the next stage.

FIG. 4b shows some failure cases, where the performance of a processing stage is worse than the performance at the previous stage. This happens when the previous stage misclassifies the majority of a region, and the mistakes are further amplified in the subsequent processing stages.

### 1.3. Hyper-Parameters for Consistency Loss

Consistency loss is an important factor in the system of the present invention. To understand its contribution to the overall performance, the results of several experiments are shown in Table 2. Overall, without using consistency loss (i.e., α=0), the mIoU (mean Intersection over union) is 60.93%. When using consistency loss (i.e., α=0.2) with zero-tolerance margin (λ=0), the mIoU on the test set increases by 1.2% to 62.15%. The mIoU further increases to 62.61% if the margin value λ is set to 0.05. In all experiments described in table 2, L₂ was used for the consistency loss. Also, L₁ was used for the consistency loss in some experiment, but it led to worse performance (mIoU=61.36%). Also, the experiments with having overlapping patches during inference increased the processing time but did not yield any performance gain (mIoU=62.53%).

TABLE 2

| α | λ | mIoU(%) |
|---|---|---|
| 0 | n/a | 60.93 |
| 0.2 | 0 | 62.15 |
| 0.2 | 0.05 | 62.61 |
| 0.2 | 0.1 | 62.55 |

### 1.4. Different Backbones and Number of Scales

MagNet can be used with any backbone network. Table 3 shows the performance of MagNet with three diffrent backbones: U-Net, DeepLabv3+, and ResNet-50 FPN. In all cases, the overall performance indicator, mIoU, increases as MagNet move from one scale level to the next. MagNet can also be used with different numbers of scale levels. In the experiments described in table 3, MagNet have used three scales: 2448->1224->612. The experiments performed an ablation study, where it used only two scales, jumping directly from the coarsest to the finest scales: 2448->612. The performance of these two variants is shown in Table 4. In both cases, the mIoU increases as MagNet move from one scale level to the next, and this indicates the robustness of MagNet with the distance between two scale values. On the other hand, the method with three scales is significantly better the method with only two scales. This illustrates the importance of having an intermediate scale connecting the two extreme ends of the scale space, and this justifies the need for the multi-scale segmentation system.

TABLE 3

| Backbone | Patch size | # patches | mIoU(%) | Memory(MB) |
|---|---|---|---|---|
| U-net [27] | 2448 × 2448 | 1 | 43.12 | 1813 |
| U-net [27] | 1224 × 1224 | 1 + 4 | 47.02 | 1713 |
| U-net [27] | 612 × 612 | 1 + 4 + 16 | 47.42 | 1723 |
| DeepLabv3+ [2] | 2448 × 2448 | 1 | 61.30 | 1541 |
| DeepLabv3+ [2] | 1224 × 1224 | 1 + 4 | 62.81 | 1441 |
| DeepLabv3+ [2] | 612 × 612 | 1 + 4 + 16 | 64.49 | 1417 |
| Resnet-50 | 2448 × 2448 | 1 | 58.60 | 1481 |
| FPN [28] | | | | |
| Resnet-50 | 1224 × 1224 | 1 + 4 | 62.61 | 1407 |
| FPN [28] | | | | |
| Resnet-50 | 612 × 612 | 1 + 4 + 16 | 67.45 | 1369 |
| FPN [28] | | | | |

TABLE 4

| Scale # | Patch size | # patches | mIoU(%) | Memory(MB) |
|---|---|---|---|---|
| 1 | 2448 × 2448 | 1 | 58.60 | 1481 |
| 2 | 612 × 612 | 1 + l6 | 64.86 | 1355 |
| 1 | 2448 × 2448 | 1 | 58.60 | 1481 |
| 2 | 1224 × 1224 | 1 + 4 | 62.61 | 1407 |
| 3 | 612 × 612 | 1 + 4 + 16 | 67.45 | 1369 |

### 2. INRIA Aerial

This dataset contains 180 satellite images of resolution 5000×5000 pixels. Each image is associated with a binary segmentation mask for the building locations in the image. There is class imbalance between the building class and the background class. The experiments trained and evaluated MagNet on this dataset with the same train, validation, and test splits used by GLNet, which have 127, 27, and 27 images respectively.

TABLE 5

| | | | |
|---|---|---|---|
| Model | Patch size | #patches | mIoU(%) |

Downsampling

| | | | |
|---|---|---|---|
| FCN-8s [20] | 5000 × 5000 | 1 | 38.65 |
| U-net [27] | 5000 × 5000 | 1 | 46.58 |
| SegNet [1] | 5000 × 5000 | 1 | 51.87 |
| DeepLab3+ [2] | 5000 × 5000 | 1 | 52.96 |

Context aggregation

| | | | |
|---|---|---|---|
| GLNet [4] (global) | 5000 × 5000 | 1 | 42.50 |
| GLNet [4] (local) | 536 × 536 | 121 | 66.00 |
| GLNet [4] (aggregation) | mixed | 1 + 121 | 71.20 |
| MagNet-1 | 5000 × 5000 | 1 | 51.68 |
| MagNet-2 | 2500 × 2500 | 1 + 4 | 56.36 |
| MagNet-3 | 1250 × 1250 | 1 + 4 + 16 | 68.95 |
| MagNet-4 | 625 × 625 | 1 + 4 + 16 + 64 | 73.40 |

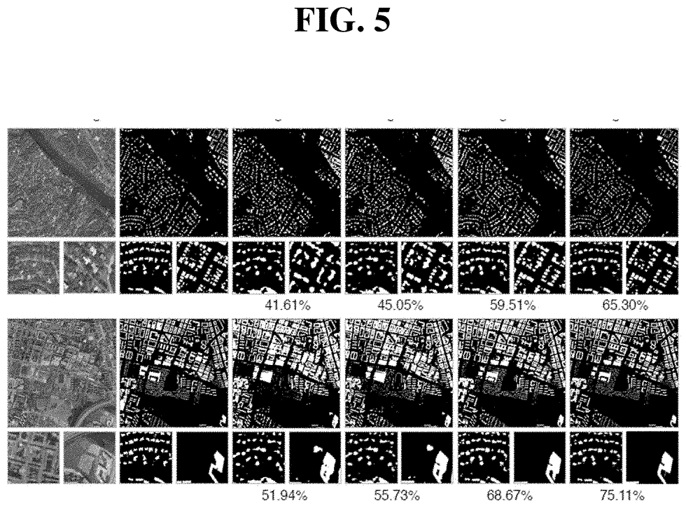

As in the previous subsection, the experiments also used the Feature Pyramid Network (FPN) with ResNet-50 backbone. Because of the larger image size, the experiments in this subsection extend the system to have four scale levels with the patch sizes being 5000, 2500, 1250, and 625. For a fair comparison, it is assumed that all segmentation network modules (of MagNet or any other methods) have the same input size of 536×536. That is to resize an input image or image patch to 536×536 pixels before putting through a segmentation unit. Table 5 shows the mIoUs for various methods. The final output of MagNet, MagNet-4, has mJoU of 73.4%, which is significantly better than the results obtained by any other method. In particular, MagNet-4 outperforms GLNet, which is the method that aggregate local and global network branches without any intermediate scales. For MagNet, the mIoU there is a consistent increase between two scale levels. FIG. 5 shows some qualitative results, where the segmentation maps are refined and improved as MagNet analyzes the images at higher and higher resolution.

### 3. Indian Diabetic Retinopathy Image Dataset (IDRID)

IDRID is a typical example of medical image datasets, where the images are very large in size, but the regions of interest are tiny. For IDRID, the image size is 3410×3410 pixels, and the task is to segment tiny lesions. There are four different types of lesions: microaneurysms (MA), hemorrhages (HE), hard exudates (EX), and soft exudates (SE). The experiments in this subsection used the EX subset containing 231 training images and 27 testing images. Following the leading method on the leaderboard of the segmentation challenge as reported in Idrid: Diabetic retinopathy-segmentation and grading challenge in Medical image analysis 59, 101561 (2020) of Porwal, P., Pachade, S., Kokare, M., Deshmukh, G., Son, J., Bae, W., Liu, L., Wang, J., Liu, X., Gao, L., et al. (incorporated herein by reference), the experiments used VRT U-Net as the backbone network.

The size of the input image to this network was set to 640×640. The experiments trained a MagNet with three scale levels: 3410->1705->682. Given the high variation in illumination for fundus images, the experiments applied a data pre-processing step as reported in Fast convolutional neural network training using selective data sampling: Application to hemorrhage detection in color fundus images. IEEE transactions on medical imaging 35(5), 1273-1284 (2016) of Van Grinsven, M. J., van Ginneken, B., Hoyng, C. B., Theelen, T., S'anchez, C. I. (incorporated herein by reference) to unify the image quality and sharpen the texture details. The mIoU of various methods are shown in Table 6. As can be seen, MagNet yields highest mIoU of 53.28%.

TABLE 6

| | | | |
|---|---|---|---|
| Model | Patch size | # patches | mIoU(%) |

Downsampling

| | | | |
|---|---|---|---|
| FCN-8s [20] | 3410 × 3410 | 1 | 14.06 |
| DeepLabv3+ [2] | 3410 × 3410 | 1 | 24.66 |
| SegNet [1] | 3410 × 3410 | 1 | 34.84 |
| VRT U-net | 3410 × 3410 | 1 | 41.64 |

Patch processing

| | | | |
|---|---|---|---|
| VRT U-net | 682 × 682 | 25 | 48.64 |

Context aggregation

| | | | |
|---|---|---|---|
| GLNet [4] (global) | 3410 × 3410 | 1 | 34.56 |
| GLNet [4] (local) | 640 × 640 | 36 | 41.10 |
| GLNet [4] (aggregation) | mixed | 1 + 36 | 49.17 |
| MagNet-1 | 3410 × 3410 | 1 | 41.64 |
| MagNet-2 | 1705 × 1705 | 1 + 4 | 40.61 |
| MagNet-3 | 682 × 682 | 1 + 4 + 25 | 53.28 |

The present invention proposes a MagNet that is a multi-scale segmentation system for a high resolution image. The MagNet may segment an image into patches and may generate high resolution segmentation output in a state in which usage of a graphics processing unit (GPU) memory is not overloaded.

To avoid a problem of being too global or local, patches at various scales from a coarsest scale level to a finest scale level may be taken into account. The MagNet includes a plurality of segmented stages, an output of one stage may be used as an input of a next stage, and a segmented output may be gradually adjusted.

In an exemplary example, an experiment of the MagNet was performed on three ultra-high resolution image data sets. In the experiments, it was confirmed that, in terms of mean intersection-over-union (mIoU) performance, a margin of the MagNet was improved by 2% to 4% as compared with a previous state-of-the-art method.

A multi-scale segmentation system according to the present invention can segment a high resolution image without overloading usage of a GPU memory and without losing detailed information in an output segmentation map.

In addition, the ambiguity of a local patch can be resolved.

Furthermore, details lost due to downsampling can be recovered.

The term “unit” or “device” used in the specification refers to a software or hardware component, such as a field-programmable gate array (FPGA) or an application-specific integrated circuit (ASIC), which executes certain tasks. However, the terms “unit” or “device” are not limited to the software or hardware component. A unit or a device may be configured to reside in an addressable storage medium and configured to operate one or more processors. Thus, a unit or a device may include, by way of example, components, such as software components, object-oriented software components, class components and task components, processes, functions, attributes, procedures, subroutines, segments of program code, drivers, firmware, microcode, circuitry, data, databases, database structures, tables, arrays, and parameters. The functionality provided in the components and units may be combined into fewer components and units or further separated into additional components and units. In addition, the components and units may be implemented such that the components and units operate one or more CPUs in an apparatus or a security multimedia card.

Although the present invention has been described with reference to the exemplary embodiments of the present invention, those of ordinary skill in the art should understand that the present invention may be modified and changed in various ways within a scope that does not depart from the spirit and area of the present invention described in the claims below.

What is claimed is:

1. A multi-scale segmentation system comprising a plurality of processing devices that correspond to multiple image scale levels, wherein the multi-scale segmentation system applies for having any number of image scale levels and wherein each processing device that corresponds to a specific image scale level is configured to:
receive a source image and one or more output segmentation maps generated from one or more previous processing devices;
divide the received source image in association with the received one or more output segmentation maps into image patches, wherein a size of image patches corresponds to the specific image scale level; and
identify semantic objects in the image patches to generate an output segmentation map.

2. The multi-scale segmentation system of claim 1, wherein each processing device includes:
a preprocessing unit which processes the source image in association with the one or more segmentation maps output from the one or more previous processing devices;
an image patch unit which divides the input source image processed in association with the one or more segmentation maps by the preprocessing unit into the image patches having a preset size;
a downsampling unit which performs downsampling on the divided image patches;
a segmentation unit which identifies the semantic objects in the downsampled image patches to output segmentation images;
an upsampling unit which performs upsampling on the segmentation images; and
an image combining unit which combines sets of the upsampled segmentation images to generate the output segmentation map.

3. The multi-scale segmentation system of claim 2, wherein the segmentation unit includes a neural network which learns segmentation using labeled learning data to output the segmentation images.

4. The multi-scale segmentation system of claim 3, wherein the segmentation unit is trained by optimizing a focal loss between a mask of an output segmentation map and a segmentation mask of a ground truth.

5. The multi-scale segmentation system of claim 4, wherein the segmentation unit learns segmentation by calculating a consistency loss based on the consistency of the output segmentation map with segmentation maps of all previous processing devices and then applying a loss function calculated according to a weighted linear combination value of the focal loss and the consistency loss.

6. The multi-scale segmentation system of claim 1, wherein a size of a current processing device image patch is smaller than a size of a previous processing device image patch.
